(19) United States
(12) Patent Application Publication
(10) Pub. No.: US 2014/0004268 A1
(43) Pub. Date: Jan. 2, 2014

(54) MATERIAL FOR COLOR AND SURFACE PREPARATION FOR POOLS AND SPAS AND METHOD OF APPLICATION

(71) Applicant: AMERICAN POOL, INC., (US)

(72) Inventor: Steven D. Owens, Broken Arrow, OK (US)

(73) Assignee: AMERICAN POOL, INC., Broken Arrow, OK (US)

(21) Appl. No.: 13/715,961

(22) Filed: Dec. 14, 2012

Related U.S. Application Data
(60) Provisional application No. 61/570,755, filed on Dec. 14, 2011.
(60) Provisional application No. 61/730,890, filed on Nov. 28, 2012.

(51) Int. Cl. C09D 7/12

(52) U.S. Cl. CPC C09D 7/1216
USPC 427/407.1; 524/442; 524/429

(57) ABSTRACT

The composition is applied in two or three parts. In a two part process, a sodium silicate/color mixture is first applied and allowed to dry. In a second part, an acid, lithium, or potassium lock-in solution is applied. In a three part application procedure, the first part is a sodium silicate mixed with a diluted water based acrylic stain of a desired color. The third part includes a sodium silicate based clear coat (with no color mixed in) that is applied over the color coat. A second part including the lock-in solution is applied over the third part clear coat.

### CROSS REFERENCE TO RELATED APPLICATIONS

This application claims the benefit of U.S. Provisional Application No. 61/570,755 filed Dec. 14, 2011, as well as U.S. Provisional Application No. 61/730,890 filed on Nov. 28, 2012, herein incorporated by reference in their entireties for all purposes.

### FIELD OF THE INVENTION

The present invention relates to sealants for pool and spa surfaces and particularly sealants for use on plaster, pebble, glass, and aggregate finishes that have been applied to structural concrete swimming pools and spas.

### BACKGROUND OF THE INVENTION

Swimming pools and spas are commonly constructed of cementitious compositions. These compositions include cement as a component. It is common to coat these cementitious structures with a surface material. It is further known that it is desirable to include colored particles or pigments to these surface materials to produce an aesthetically pleasing finished surface. It has been found that it is often preferable to imbed, mix or blend this pigment into the surface material as opposed to coat or paint the surface material substrate with the pigment. Once the pigment is imbedded, mixed, or blended into the surface material, it is applied to the cementitious structure of the pool or spa.

A known problem with the inclusion of such pigments is the fact that it is often difficult to thoroughly mix the pigment into the surface material. As a result, the overall color and texture of the applied surface material may not be uniform.

In addition, cementitious materials commonly are exposed to ultraviolet (UV) light from the sun which causes fading, drying, and cracking of the surface material. Exposure to solvents such as water, pool chemicals, additives which include minerals, acids, alkaline fluids and the like. These additives can react with the components of the cementitious material and/or the surface material to degrade its integrity. An example may include circumstances where the solvent reacts with and/or dissolves soluble portions of the cementitious material or surface material and thereby removes the soluble or partially-soluble component or components from the cementitious substrate. This often results in weakening the cementitious material, cracking, marring or pitting of its surface, and detracting from its effectiveness and aesthetic appearance.

One common surface material applied to pools and/or spas is plaster. Plaster has historically been a useful cost efficient surface material. Most traditional plaster is white cement mixed with limestone or marble sand. Plaster, is a porous cementitious material by nature. Pigments are often mixed with plaster to color the surface material. It is estimated that a plaster pool surface material will last approximately 5 to 10 years if properly maintained.

Known disadvantages of plaster surface materials is the fact that plaster continues to absorb and/or react with pool water (solvent) and pool chemicals. As a result, plaster pool surfaces often require frequent adjustments in pool chemistry and may require additional chemicals to keep a balanced pool water chemistry. Being porous, plaster surface materials are susceptible to staining and bacteria growth. Plaster pool surface materials are also subject to the disadvantageous fading, cracking and chemical interaction as discussed above.

A need, therefore, exists for a sealant for a cementitious pool substrate which is durable, fade resistant and chemical and UV resistant.

Another popular pool surface material is a pebble or aggregate pool finish. A pebble surface material begins with a plaster to which a pebble aggregate is mixed in. A powdered colorant is commonly added to the plaster to provide an additional aesthetic effect. This (colored) plaster, mixed with pebble aggregate is then applied to a pool substrate, commonly concrete, to achieve a pool or spa surface that is characterized by color of the plaster and the type and color of pebble selected. Pebble aggregate pool surfaces are more costly than traditional plaster but are believed to be more economical to maintain. In addition, a pebble aggregate surface is expected to last longer than a plaster surface. If the pool or spa is maintained properly, a pebble aggregate surface can last twelve (12) to twenty (20) years depending on the quality of the application and/or climate.

Pebble aggregate surfaces too, however, have drawbacks. Although the pebbles themselves typically do not crack and/or fade over time, the plaster in which they are mixed suffers from the same drawbacks as with plaster alone. Over time, and as subjected to the elements (sun) and pool chemicals, colored plaster will fade, chip, and/or crack. In addition, depending on the application, pebble aggregate surfaces can be rough to the touch. Accordingly, a need also exists for a sealant applied to a pebble aggregate pool substrate which is vibrant (and remains so), durable and results in a surface which is smooth to the touch.

### SUMMARY OF THE INVENTION

The invention consists of a mixture combining a sodium silicate based formula with a colorant. This mixture is applied to a cement or concrete substrate utilizing any type of spray apparatus. The substrate could include a pool, spa, or any other aesthetically colored water basin, hereafter “pool” or “swimming pool”.

The color mixture is the first coat of a two or three coat application process. For a two coat application, the second coat utilizes an acid based, or lithium based, or potassium based setting chemistry. This chemistry interacts with the base color coat causing a reaction that speeds and intensifies the color setting processing.

A third step application may be added to provide a significant sheen and added surface protection to the first step color coat. In this application procedure, the sodium silicate color mixture is applied first and allowed to dry. The second coat is a sodium silicate based clear coat (no color mixed in) that is sprayed over (on top of) the color coat. The second “clear coat” is allowed to dry. Finally, the “setting solution” coat is sprayed on and is allowed to dry and thoroughly set in.

Predicated on the application purpose, once thoroughly dried and set, the application(s) provide for a colored UV stabilized protected finish which adds strength and additional durability to the original substrate. The invention can be applied to new or existing (old) concrete, or cementitious substrates.

The present invention is a composition providing a surface preparation for a cementitious swimming pool including the following: a.) a first part including a mixture of water based acrylic stain and sodium silicate; b.) a second part including a lock-in solution selected from a group consisting of an acid, lithium, or potassium in solution; c.) a third part including a clear coat solution.

The present disclosure also includes a method of providing a surface preparation for a cementitious swimming pool substrate, including the following steps: obtaining a mixture of water based acrylic stain and sodium silicate; applying the mixture to a pool substrate; obtaining a lock-in solution; applying the lock-in solution to said pool substrate over said mixture.

An alternate embodiment of the present disclosure includes a method of providing a surface preparation for a cementitious swimming pool, including the steps of: obtaining a mixture of acrylic stain and sodium silicate; applying said mixture to a pool substrate; allowing said mixture to dry on said pool substrate; obtaining a sodium silicate clear coat solution; applying said sodium silicate clear coat solution to said pool substrate; allowing said clear coat solution to dry on said pool substrate; obtaining a lock-in solution; applying said lock-in solution to said pool substrate; allowing said lock-in solution to dry on said pool substrate; filling the cementitious swimming pool.

### DESCRIPTION OF THE INVENTION

The invention of the present disclosure is intended for use on plaster, pebble, glass, and aggregate finishes that have been applied to structural cementitious (concrete) swimming pools, spas and the like. The material of the present disclosure is designed for use on both new and old surfaces and is particularly suited for use on porous swimming pool cementitious (concrete) substrates.

The invention consists of a mixture combining a sodium silicate based formula with a colorant. This mixture is applied to a cement or concrete substrate utilizing any type of spray apparatus.

In a preferred embodiment, the mixture is applied in a two or three coat process. In a two coat application process, a sodium silicate color mixture is first applied and allowed to dry. In a second coat, a setting solution consisting of an acid, lithium, or potassium lock-in solution is applied (sprayed) and allowed to dry.

In a three part preferred application procedure, the first coat is the color coat consisting of a sodium silicate solution including a water based acrylic stain of a desired color mixed with a sodium silicate solution. The second coat includes, preferably, a sodium silicate based clear coat (with no color mixed in) that is applied (preferably sprayed) over the color coat. This second clear coat is allowed to dry. Once dry, a third coat including the setting solution may be applied (preferably sprayed) over the second coat and allowed to dry and thoroughly set in. This clear coat may utilize an acid, lithium, or potassium based setting chemistry. This third coat chemically interacts with the base color coat in order to speed and intensify the color setting process.

Once thoroughly dried and set, the described applications provide for a colored, UV stabilized protected finish which adds strength and additional durability to the original substrate. The applications of the present disclosure can be applied to new or existing (old) concrete, or cementatious substrates. In an application in an existing pool or cement substrate, it is believed that the cost of the application of the process of the present disclosure would be approximately 15%-25% of the cost of replastering over the existing surface.

The preparation of the present disclosure is a multiple color choice spray applied penetrating material. In a preferred embodiment it is used on Portland Cement based (concrete) substrates used to water-proof and finish the inside of such concrete swimming pool shells. Concrete pools such as poured, stacked concrete, shotcrete, gunite pools and the like that are finished with a plaster or aggregate Portland cement based substrate application are particularly suitable for the present material. Structural integrity and positive bonding of the substrate to the concrete pool shell is critical to successful color applications. The material of the present disclosure creates and internal shield in the concrete pores and cavities that reduces vapor emission and makes the substrate more dense as well as draws the color deep into the substrate. The material of the present disclosure contains a sealer and chemicals that react with the alkali and alkaline present in Portland cement to create this strength enhancement and vapor barrier.

The sealing and coloring preparation of the present disclosure is particularly suited for application on pools and/or spas. Most particularly pools and/or spas constructed of Portland Cement (concrete). The preparation of the present disclosure penetrates the pores in the concrete to seal the concrete substrate. As it penetrates, the material may carry the colorant deep within the substrate thereby producing a rich, vibrant and very durable color application for pools and/or spas.

The sealing and color preparation of the present disclosure includes, generally two components. The first component is a preparation that penetrates the material porosity of the concrete substrate. This material is known commercially as sodium silicate and can be found in crystalline waterproofing materials. Such materials are available commercially as Penekrete® available from Super-Krete International, Inc., El Cajon, Calif.; Krystol® available from Kryton International, Inc.; Xypex Crystalline Waterproofing available from Xypex Chemical Corporation, British Columbia, Canada; and Permaquik® Crystalline waterproofing available from Tremco Incorporated, Beachwood, Ohio, as well as others.

The chemicals contained in commercial sodium silicate materials employ moisture for chemical reaction from within the matrix of the substrate. When combined with lime, alkali, and the like present in the substrate, these chemicals form long chained complexes, which crystallize and penetrate deep into the capillaries of the concrete substrate thereby preventing the passage of moisture through the substrate.

The formation of the long chain complexes is continuous as long as moisture is present in the substrate, significantly reducing the concrete substrate's natural porosity by filling voids and cracks caused by shrinkage. The crystalline material does not prevent the substrate from breathing as the crystalline does not create a vapor barrier. If no moisture is present, the “crystals” will lie dormant until moisture reappears and then will react to seal the cause of the moisture penetration.

The second component of the preparation is a colorant. The colorant could be any suitable colorant and preferably water based acrylic stain. The colorant could be any suitable or desired color. The addition of the sodium silicate and the colorant forms a mixture which is capable of penetration up to approximately 8.5 inches into the concrete substrate and carries the colorant with it. Thus, the application of the mixture of the present disclosure forms a moisture sealant which produces a smooth surface with a rich, vibrant, durable color layer.

Characteristics of the material include:
100% Water Soluble
Y.O.C.—100 Grams Per Litre
Non-Toxic
Flashpoint—Non-Flammable
Appearance—Pale Clear with Color
Odor—None
Cleanup—Tools and Equipment are cleaned with Clean Water. No harsh, toxic or environmentally unfriendly solvents are required.

A preferred sample of the material of the present disclosure includes:
Ph 1.3
Specific Gravity=1.04
Viscosity 1000 cps

The material of the present disclosure is preferably an odorless, non-toxic, nonflammable, low viscosity, spray applied liquid formulation. The material penetrates the prepared pool surface to provide an internal moisture barrier that strengthens, preserves, and colors new and old Portland cement based substrates. When properly applied, the material penetrates deeply and becomes an integral part of the cement. The material penetrates deep into the pores and cavities of the prepared surface as well as small hairline cracks. A shield structure thereby develops within the concrete which forms a seal against the passage of water and other liquids. Moisture vapor is considerably reduced.

The material of the present disclosure inhibits cement dusting without changing surface appearance, texture, or bonding. In addition, the material minimizes cement deterioration and color degradation by resisting penetration of acids, alkalis, oils, and salts. The material further resists below grade hydrostatic pressure. However, it is preferable that sub-surface flowing water be stopped before the material is applied. Once applied, the material is resistant to staining.

The material of the present disclosure is preferably designed for Portland cement based concrete/cement or other substrates which contain calcium carbonate and lime. This material is not preferred for metal, plastic, fiberglass, wood, or clay substrates. However, the material will protect metal and other strengthening strata contained within the concrete substrate.

### Surface Preparation

Surfaces to be colored and/or sealed with the material of the present disclosure should preferably be structurally sound and bonded to a concrete pool shell. However, some surface defects, hairline or shrink cracks, and spalls can typically be repaired to receive the material.

If the surface is coated with heavy grease, oils, rubbers based or acrylic paint or other impervious coatings, it is preferred that such coatings be removed so as to alow the material of the present disclosure to preferably be allowed to penetrate through the surface of the cement.

The material of the present disclosure is preferably to be used on “Porous” cement substrates to ensure proper penetration. If surface porosity is uncertain, it is preferred to apply a water surface test. To do this, pour a small amount of water on the surface that is to be colored. If the water beads on the surface and is not absorbed into the cement, open up the surface by acid etching or other known mechanical means to ensure proper penetration of the material. After acid etching the surface, apply a liquid TSP solution to neutralize the remaining acid in the concrete pores. Retest surface to ensure the surface absorbs water. Particular attention should be focused on any slick, hard troweled surface areas.

Next, clean the surface to be colored with liquid TSP.

### Application

Dampen surface prior to coloring using a low pressure sprayer. Mist the surface with a fine spray. Do not saturate.

Apply the material full strength. Do not dilute.

Saturate the surface completely with the material at an approximate rate of 200-250 square foot per gallon. For small areas, low pressure sprayers (hand pump garden sprayer) will work. For regular to large pools, airless spray equipment is recommended. Do not allow the material to puddle. Evenly spread the material with a soft bristled broom or paint brush. Continue to saturate any area that dries too quickly. Any excess areas should be removed with a wet vac or sponge mop. The material should be allowed to puddle on the surface in order to achieve the optimum uniform cover and color aesthetics. However, it is contemplated that artistic applications of the material may be employed to achieve different aesthetic results. Several passes with spray equipment may be required to achieve desired color coverage.

Outdoors—dampen surface with a fine water mist using a low pressure sprayer approximately one hour after applying color. (Time could be less depending on temperature, humidity, wind, weather conditions, etc.).

Once the material is applied, it is generally undesirable to flush the surface with water as some color could be washed away by this action.

### New Plaster/Pebble Color Application

As soon as surface finishing has been completed, and when surface supports foot traffic, acid etch any “Hard Troweled” surface areas.

Then neutralize the surface with liquid TSP.

Spray apply the material of the present disclosure as described above under application. Surface will cure with the material producing a smooth hardened waterproof surface.

The material of the present disclosure is effective in hot or windy conditions since it cures uniformly, increase surface strength and density, and inhibits hairline shrinkage cracking and surface dusting.

Once applied, the material of the present disclosure should preferably be immediately removed from aluminum, glass, (including eyeglasses), and pool tiles. Also remove any spots or overspray from surrounding coping, decks, rockwork, etc.

Wipe off immediately with a wet sponge or cloth.

It is preferable not to apply the material to wall tile, pool tile spotters, plastic fittings, etc. All these areas should be taped and covered before application of color.

The material should not be applied or stored at freezing temperatures. Storage should be maintained at 45 degrees minimum surface temperature is recommended. It is preferable to keep the material from freezing.

Care should be taken to protect vegetation and adjacent areas from direct or overspray.

### Mixing

In a preferred embodiment, the material should be employed full strength, and not diluted. Thoroughly stir material preferably with a mixer tool. Strain material and pour into sprayer unit.

Advantages of the present disclosure:
Increases cement strength minimizing dusting, spalling, and hairline shrink cracking
Penetrates substrates increasing color life
Reduces moisture vapor transmission
Protects reinforcing steel from rust
Assists in preventing freeze/thaw damage
Reduces/Prevents Efflorescence
Purges excess alkali, lime, acids from cement substrate
Seals against seepage from hydrostatic pressure
Promotes color longevity and is more resistant to staining
Resistant to salt and chemical attack by forming a protective coating around individual cement particles and aggregates.
Provides a smooth finish, even over rough or etched surfaces.

### Application Example

An example application procedure for applying the colorant material of the present disclosure may include the following:

Surface Preparation

The surface to which the mixture of the present disclosure is to be applied should be prepared 24-48 hours prior to application of the material of the present disclosure. This could include an acid wash to remove cement slurry and expose the aggregate. Once the surface is acid washed, any remaining acidity may be neutralized by an application of a base such as trisodium phosphate (TSP). Once neutralized, the surface is rinsed and allowed to dry.

Color Layer Application

In a first step, a sodium silicate stain mixture is prepared. In a preferred embodiment, a water based acrylic stain of a selected color is obtained. The concentration of color may be adjusted by the addition of deionized (most preferred) or distilled water preferably of a pH of 6.0-8.0 with 6.8 being preferred. This diluted water based acrylic stain solution is then mixed with a sodium silicate solution of a required volume or concentration in order to achieve a desired final color intensity or color shade. Preferably, a stain color is selected which is consistent with the substrate. In other words, a darker stain in preferable for a dark substrate. While it is possible to apply a dark stain to a light substrate, it is often difficult to apply a light stain to a dark substrate in order to achieve a resulting light color In a preferred embodiment a sodium silicate concentration of 10%-30% may be used with a concentration of 15%-22% being more preferable and a concentration of 18%-21% being a most preferred but with an approximately 20% sodium silicate solution being optimal. This sodium silicate water based acrylic stain solution is applied over the substrate such as a swimming pool or spa surface, preferably by using a sprayer such as a common pump sprayer or an airless spray technique. This stain color/color layer should be applied to a dry substrate. In the event it is determined that the substrate is too dark, or over-colored, the substrate can be washed with water to dilute/remove a desired amount of color since the stain is water based.

Optional Layer

In a three coat application process of the surface treatment of the present disclosure, a clear coat layer may be applied over the first color/stain layer. The second layer may include a sodium silicate solution which does not include the stain/color material may be applied over the sodium silicate/colorant layer. In this step, a preferably 10%-30% sodium silicate solution is obtained by mixing sodium silicate with water, preferably of a pH of 6.0-8.0 with a pH of 6.8 preferred. A 15%-20% range of sodium silicate is more preferred with an approximately 20% sodium silicate concentration most preferred. In this step tap water may be used, however, deionized or distilled may be substituted. This second layer of sodium silicate solution not containing the colorant is applied by spraying over the first application of the stain/colorant layer preferably immediately upon drying of the first layer application. The second layer may be applied by spraying in the same manner as described above. This second coat of sodium silicate solution acts as a clear coat layer that provides an additional layer of protection over the colorant layer and also imparts a visually appealing affect.

Lock-In Layer

In a third step a lock-in layer is applied over the clear coat layer. The lock-in layer is preferably so as to seal the first two layers to provide durability and resistance to UV and the effects of chemicals in the pool or spa. This coat includes a mist application of a lock-in solution which is preferably an acid based, lithium based, or potassium based solution. In one embodiment, the lock-in solution is an acidic water solution prepared by adjusting the pH of approximately 6.0 to 6.9 with 6.8 preferred. In a second embodiment, the lock-in solution contains lithium nitrate (LiNO₃) in solution. In this embodiment, a suitable lithium nitrate solution may be obtained from FMC Corporation (www.fmclithium.com). It is believed that this application causes a chemical reaction with the base stain/color coat which speeds and intensifies the color setting process. This mist is applied preferably as soon as the second layer or coat or clear coat layer is applied. Once this application is dry to the touch, then the pool or spa may be filled with water.

In a basic embodiment, the second clear coat layer may be eliminated such that the lock-in mist layer is applied directly to the stain/colorant layer.

Thus, the invention, once thoroughly dried and set, provides for a colored UV stabilized and chemically protected finish which adds strength and durability to the original substrate. In addition, an aesthetically pleasing colorant layer is applied which is durable, fade, chemical and damage resistant.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A method of providing a surface preparation for a cementitious swimming pool substrate, comprising:
obtaining a mixture of water based acrylic stain and sodium silicate;
applying said mixture to a pool substrate;
obtaining a lock-in solution;
applying said lock-in solution to said pool substrate over said mixture.

2. The method of claim 1 further including:
obtaining a sodium silicate clear coat solution;
applying said sodium silicate clear coat solution to said pool substrate over said mixture.

3. The method of claim 2 wherein said sodium silicate clear coat solution is applied to said pool substrate before said lock-in solution.

4. The method of claim 2 wherein said sodium silicate clear coat solution includes a mixture of between 10% and 30% sodium silicate.

5. The method of claim 4 wherein said sodium silicate solution includes approximately 20% sodium silicate and approximately 80% water.

6. The method of claim 1 wherein said mixture comprises:
obtaining a water based acrylic stain;
diluting said water based acrylic stain with water;
mixing said diluted water based acrylic stain with sodium silicate in order to achieve a desired color intensity of said mixture.

7. The method of claim 6 wherein said mixture includes between approximately 10% and 30% sodium silicate.

8. The mixture of claim 7 wherein said mixture includes between approximately 15% and 22% sodium silicate.

9. The mixture of claim 8 wherein said mixture includes approximately 20% sodium silicate.

10. The method of claim 1 wherein said lock-in solution is selected from a group consisting of an acid, lithium, or potassium in solution.

11. The method of claim 10 wherein said lock-in solution is a lithium nitrate solution.

12. A method of providing a surface preparation for a cementitious swimming pool, comprising the method comprising:
obtaining a mixture of acrylic stain and sodium silicate;
applying said mixture to a pool substrate;
allowing said mixture to dry on said pool substrate;
obtaining a sodium silicate clear coat solution;
applying said sodium silicate clear coat solution to said pool substrate;
allowing said clear coat solution to dry on said pool substrate;
obtaining a lock-in solution;
applying said lock-in solution to said pool substrate;
allowing said lock-in solution to dry on said pool substrate;
filling the cementitious swimming pool.

13. The method of claim 12 wherein said lock-in solution is applied over said clear coat solution and said clear coat solution is applied over said mixture of acrylic stain and sodium silicate.

14. The method of claim 12 further including:
obtaining a water based acrylic stain;
diluting said water based acrylic stain with water;
mixing said diluted water based acrylic stain with sodium silicate in order to achieve a desired color intensity of said mixture.

15. The method of claim 14 wherein said mixture includes between approximately 18% and 21% sodium silicate.

16. The method of claim 12 wherein said sodium silicate clear coat solution includes approximately 18% and 21% sodium silicate and between 79% and 82% water.

17. The method of claim 12 wherein said lock-in solution is selected from a group consisting of an acid, lithium, or potassium in solution.

18. A composition providing a surface preparation for a cementitious swimming pool, comprising:
a.) a first part including a mixture of water based acrylic stain and sodium silicate;
b.) a second part including a lock-in solution selected from a group consisting of an acid, lithium, or potassium in solution.

19. The composition of claim 18 further comprising:
c.) a third part including a sodium silicate solution having at least approximately 18% sodium silicate.

20. The composition of claim 18 wherein said lock-in solution is lithium nitrate in solution.
